(19) United States
(12) Patent Application Publication
(10) Pub. No.: US 2017/0132728 A1
(43) Pub. Date: May 11, 2017

(54) METHOD AND SYSTEM OF AUTOMATICALLY GENERATING AN ONLINE-REAL ESTATE MAGAZINE

(71) Applicant: MAHNAZ WESTERBERG, Palo Alto, CA (US)

(72) Inventor: MAHNAZ WESTERBERG, Palo Alto, CA (US)

(21) Appl. No.: 15/210,091

(22) Filed: Jul. 14, 2016

Related U.S. Application Data
(63) Continuation-in-part of application No. 14/289,543, filed on May 28, 2014.
(60) Provisional application No. 62/362,201, filed on Jul. 14, 2016.
(60) Provisional application No. 61/936,866, filed on Feb. 6, 2014.
(60) Provisional application No. 61/829,007, filed on May 30, 2013.

(51) Int. Cl. G06Q 50/16; G06Q 30/02

(52) U.S. Cl. CPC G06Q 50/16; G06Q 30/0205

(57) ABSTRACT

In one example aspect, a computerized method of automatically generating an online-real estate magazine includes the step of determining a geographic region of interest of a user and a real-estate market segment of interest of the user. The method includes the step of obtaining a real-estate magazine content. The method includes the step of obtaining a set of real-estate listings. The set of real-estate listings are relevant to the geographic region of interest of the user. The method includes the step of automatically generating the online-real estate magazine with the real-estate magazine content and the set of real-estate listings. The online-real estate magazine is accessible via a specified web page. The online-real estate magazine comprises a set of digital images of the set of real-estate listings. The method includes the step of integrating the online-real estate magazine with a real-estate service web page.

### CROSS-REFERENCE TO RELATED APPLICATIONS

This application is a claims priority to U.S. provisional patent application No. 62/362,201, titled Methods And Systems Of An Online Real Estate Service and filed on Jul. 14, 2016. This application is continuation in part of and claims priority to U.S. patent application Ser. No. 14/289,543 titled Method And System Of Presenting A Real Estate Agent To A Lead In A Real Estate Computing Platform and filed on 28 May 2014. U.S. patent application Ser. No. 14/289,543 claims priority to U.S. provisional patent application No. 61/829,007, titled Virtual Escrow Application and filed on May 30, 2013 and U.S. provisional patent application No. 61/936,866, titled Virtual Escrow Application 2 and filed on Feb. 6, 2014. These provisional and utility applications are hereby incorporated by reference in their entirety.

### BACKGROUND

1. Field

This application relates generally to the real-estate field, and more particularly to a system, method and article of manufacture of automatically generating an online-real estate magazine.

2. Related Art

A real estate agent or agency can maintain a website. The real-estate agency website can include static information about the real-estate agency. For example, the profile(s) of the real-estate agent(s) can be included on the website. Contact information about the real-estate agency can also be included, along with various other static marketing information. At the same time, information about a local real-market can be dynamic. User's may be interested in reading and learning more about their own particular real-estate interests/questions, as well as, news and forecasts about their particular real-estate market of interest. Accordingly, improvements to how real-estate agencies provide information about real-estate markets are desirable. These improvements can present the real-estate information in an engaging and interesting manner to the user.

### BRIEF SUMMARY OF THE INVENTION

In one example aspect, a computerized method of automatically generating an online-real estate magazine includes the step of determining a geographic region of interest of a user and a real-estate market segment of interest of the user. The method includes the step of obtaining a real-estate magazine content. The method includes the step of obtaining a set of real-estate listings. The set of real-estate listings are relevant to the geographic region of interest of the user. The method includes the step of automatically generating the online-real estate magazine with the real-estate magazine content and the set of real-estate listings. The online-real estate magazine is accessible via a specified web page. The online-real estate magazine comprises a set of digital images of the set of real-estate listings. The method includes the step of integrating the online-real estate magazine with a real-estate service web page.

Optionally, the set of real-estate listings can be relevant to the geographic region of interest of the user. The geographic region of interest can be based on a city specified by the user and a radius around the city. The set of real-estate listings is relevant to a home type specified by the user and a home-price range specified by the user. The geographic region can be is determined by tracking a user's web browsing history. The user's web browsing history can be analyzed to automatically determine the geographic region of interest and automatically determine the home-price range based on a user's past search history and a user's past browsing history. The set of real-estate listings can be based on a high ranking in a walkability index, a high ranking school-rating index, a public transit index, a local restaurant ratings index, a local merchant ratings index and a bicycle-friendly index.

### BRIEF DESCRIPTION OF THE DRAWINGS

The present application can be best understood by reference to the following description taken in conjunction with the accompanying figures, in which like parts may be referred to by like numerals.

FIG. 1 illustrates, in block diagram format, an example system for automatically generating an online-real estate magazine, according to some embodiments.

FIG. 2 illustrates an example method of automatically generating an online-real estate magazine, according to some embodiments.

FIG. 3 provide an example computerized automated artificial-intelligence (AI) module 300, according to some embodiments.

FIG. 4 illustrates another example process of presenting updated real-estate information in a real-estate related web page, according to some embodiments.

FIG. 5 is a block diagram of an example of a real-estate computing platform, according to some embodiments.

FIG. 6 is a block diagram of a sample-computing environment that can be utilized to implement some embodiments.

FIG. 7 depicts an exemplary computing system that can be configured to perform any one of the processes provided herein.

The Figures described above are a representative set, and are not an exhaustive with respect to embodying the invention.

### DESCRIPTION

Disclosed are a system, method, and article of manufacture of automatically generating an online-real estate magazine. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Blogging platform can include a blog-publishing service that allows multi-user blogs with time-stamped and other context-aware metadata entries. A blog can be a discussion or informational site published on the World Wide Web and consisting of discrete entries (“posts”) typically displayed in reverse chronological order (the most recent post appears first).

Machine learning can include the construction and study of systems that can learn from data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Mobile device can include a handheld computing device that includes an operating system (OS), and can run various types of application software, known as apps. Example handheld devices can also be equipped with various context sensors (e.g. biosensors, physical environmental sensors, etc.), digital cameras, Wi-Fi, Bluetooth, and/or GPS capabilities. Mobile devices can allow connections to the Internet and/or other Bluetooth-capable devices, such as an automobile, a wearable computing system and/or a microphone headset. Exemplary mobile devices can include smart phones, tablet computers, optical head-mounted display (OHMD) (e.g. Google Glass®), virtual reality head-mounted display, smart watches, other wearable computing systems, etc.

Mouse hover can be include when the user moves or “hovers” the pointer over a particular area of a graphical user interface (GUI).

Natural language processing (NLP) can include natural language understanding and other algorithms that enable computers to derive meaning from human and/or other natural language input. NLP can also provide for natural language generation (e.g. convert information from computer databases into readable human language).

Online social network service can service is a platform to build social networks or social relations among people who, for example, share interests, activities, backgrounds or real-life connections. A social network service can consists of a representation of each user (e.g. a profile, an avatar, etc.), his/her social links, and a variety of additional services. Social networking can include web-based services that allow individuals to create a public profile, to create a list of users with whom to share connection, and view and cross the connections within the system.

Real estate property can consist of land or buildings (e.g. homes, commercial buildings, etc.).

Real estate agent can be a person who acts as an intermediary between sellers and buyers of real estate/real property.

Real estate lead can be a person who is interested in entering into a real-estate transaction other than the real estate agent (e.g. selling a home, purchasing a home, renting an office, and the like). For example, a real estate lead can be a potential real estate customer.

Real estate platform can be a computing system with applications for implementing various real estate dealings and transactions (e.g. viewing real estate images and videos, providing information about real estate, providing real estate agents information, etc.). Real estate platform can be implemented in a client/server and/or cloud-computing paradigm according to various example embodiments.

Process Overview

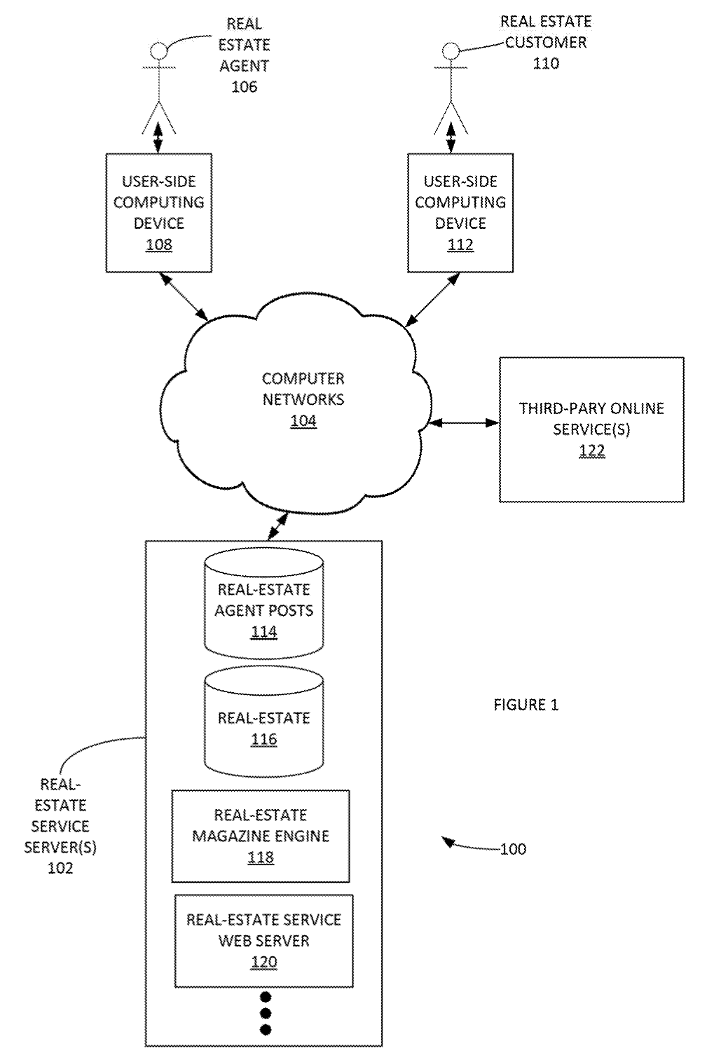

FIG. 1 illustrates, in block diagram format, an example system 100 for automatically generating an online-real estate magazine, according to some embodiments. System 100 can be used to implement an online real-estate service. The online real-estate service can include various real-estate related services provided herein (e.g. online real-estate blogs, online real-estate magazines, real-estate listing databases, real-estate agent databases, real-estate tour generation service, real-estate image collage generation service, real-estate documents generations and/or signing services, etc.). System 100 can include a real-estate service server(s) 102 can implement the various real-estate related services. Portions of system 100 related to automatically generating an online-real estate magazine are now discussed. Real-estate service server(s) 102 can include, inter alia, one or more blogging platforms. Real-estate agent(s) 106 can draft and upload real-estate related blog posts to said blogging platform. Real-estate related blog posts can include contemporary real-estate information for specified locations, market-niches, real-estate listings and their respective attributes, time periods and/or other real-estate related metadata. Real-estate service server(s) 102 can parse and analyse said blog posts into various categories (e.g. Palo Alto single family homes listed for over one million dollars, etc.). Blog posts can be stored in real-estate agent post(s) database 114. Additionally, real-estate service server(s) 102 can further include a listing of real-estate database 116 that includes an online real estate database. Real-estate database 116 can include images and other real-estate listing information. This information can be obtained via one or more application program interfaces (API) from third-party sources (e.g. online third-party service(s) 122 such as a multiple listing service).

Real-estate magazine engine 118 can automatically generate an online real-estate magazine from information in databases 114 and 116 as well as other sources (e.g. third-party maintained web sites, advertiser web sites, local government websites, and the like). Online real-estate magazine content change based on real-estate location search criteria and/or other context-awareness data. Online real-estate magazine opens “in front” of the web site and keep the context of the web page and search. Real-estate magazine engine 118 can automatically generate an online real-estate magazine specifically for one or more specified variables (e.g. location, listing price range, design attributes, etc.). For example, every blog post can include various real-estate metadata tags and/or time stamps. Real-estate magazine engine 118 can sort blog posts according to time stamps. Real-estate magazine engine 118 can select sorted bog posts based on one or more metadata tags and match these with the listings in real-estate database 116. Matched real-estate listings and the relevant blogs can then be integrated into an online real-estate magazine template. Additional information such an advertisements, local-government information, other content can also be obtained and automatically integrated into the online real-estate magazine. Real-estate magazine engine 118 can also provide online tools (e.g. via a web page interface, via a mobile-device client-side application interface, and the like) that can enable a system user (e.g. a real-estate agent associated with the real-estate customer 110 and/or real-estate listing) to modify and/or edit the online real-estate magazine. Clients and members of the public can add content to the online real-estate magazine (e.g. homes, commercial property, rental units, etc.). Additional, content in the online real-estate magazine can be added to a user's favorite list (in addition to the information they get when searching for homes).

The specified variables used by real-estate magazine engine 118 can be obtained from various sources. For example, the specified variables can be search engine terms obtained from a real-estate customer 110 provided search query. Specified variables can be also include attributes of real-estate customer 110 (e.g. as obtained from real-estate customer 110 browsing information, real-estate customer 110 profile, etc.).

It is noted that, in some embodiments, other real-estate professionals (e.g. mortgage brokers, contractors, analysts, etc.) can publish and maintain blogs in the blogging platform. This information can be included in the online real-estate magazine as well. Computer network(s) 104 can include the internet, LANs, WANs, cellular networks, etc.). User computing devices 108 and 112 can include personal computers, laptop computers, mobile devices, etc.

Real-estate service server(s) 102 can include other modules (not shown). For example, Real-estate service server(s) 102 can provide electronic signature technology and Digital Transaction Management (DTM) services for facilitating electronic exchanges of contracts and signed documents. Upon the completion of a real-estate transaction, the real-estate agent can select what document goes to what other entity such as a broker, lender, title, client etc. For each document, when filing in the transaction file, real-estate agents can assign which entity should be provide a specified document. Then when the transaction is complete, with a single user command, all the documents can be emailed/transferred to the parties associated with specified documents.

Real-estate service server(s) 102 can include other functionalities such as those provided infra search engines, escrow services, encryption functionalities, web server(s) 120, and the like. Real-estate service server(s) 102 can interface with local governments to provide real-estate transaction documentation and/or obtain property history documentation. Real-estate service server(s) 102 can include a user-subscription manager, user-authentication manager, scheduling/calendar interface modules, user registration and membership managers, etc. Real-estate service server(s) 102 can include functionalities for managing online money transfers via the Internet (e.g. an e-commerce payment system facilitates the acceptance of electronic payment for online transactions). In some examples, real-estate service server(s) 102 can be implemented in a cloud-computing platform (e.g. Amazon Web Services®, Microsoft Azure®, etc.).

Real-estate service server(s) 102 can maintain various real-estate attribute indices (e.g. a walkability index, school rating index, crime statistics, travel time statistics, public transit index, local restaurant ratings, local merchant ratings, bicycle-friendly index, etc.). This information can be included in database 116. Real-estate service server(s) 102 can a walkability index from walkscore.com®. This information can be included in the online magazine and/or otherwise be available via a search query. This information can be used as attributes to score homes in a tour (and/or virtual tour). For example, a customer can indicate a preference for a high walkability score. Accordingly, homes with a high walkability score can be weighted to increase their likelihood of appearance at an optimal time in a home tour. Moreover, as provided infra, these attributes can be used to generate alerts for customers/agents. For example, a customer can be near a home with a high walkability score, the real-estate service server(s) 102 can send the user an alert with information about the home and/or directions to the home. In one example, an attribute index can be generated as follows. Real-estate service server(s) 102 can sort multiple location within a specified radius of the home. For example, multiple destinations based on walking time, taking a public transit, driving time, and/or biking. Points of interest (e.g. walkable streets, high rated restaurants, high rated schools, etc.) can be located in the specified radius. Points of interest can be scored and aggregated. Accordingly, an index for each index attribute can be generated for each home. Indices can be combined with various indices weighted based on explicit and/or implied user attributes. Each home can receive an aggregated attribute index score specific to each user. These scores can be utilized to optimize any real-estate related functionality provided herein. Furthermore, indices and other home scores can be searchable by query search and/or other functionality. For example, a user can click on and/or hover a mouse over an image of a home can view various index scores (e.g. walkability, nearby school ratings, etc.). The visible scores can be selected based on explicit and/or implied user attributes (e.g. bikes to work, has three children, eats at restaurants often, etc.).

Real-estate service server(s) 102 can include web mapping service. The web mapping service can provide satellite imagery, street maps, and/or street view perspectives, as well as functions such as a route planner for traveling by foot, car, bicycle and/or with public transportation. Moreover, in some embodiments, alerts discussed herein can be provided to other parties to a real-estate transaction (e.g. mortgage brokers, lenders, sellers, buyers, painters, electricians, inspectors, etc.). Real-estate service server(s) 102 can include a calculator functionality. Accordingly, real-estate service server(s) 102 can automatically calculates the overall compensation for each real-estate agent for a transaction based on the information about the transaction and the agreements with clients and/or real-estate brokers. Real-estate service server(s) 102 can training functionalities that teach and train real-estate agent how to utilize its services. These training functionalities can be intuitive and self-contained with the online real-estate service platform without the need for additional classes. Real-estate service server(s) 102 can include service.

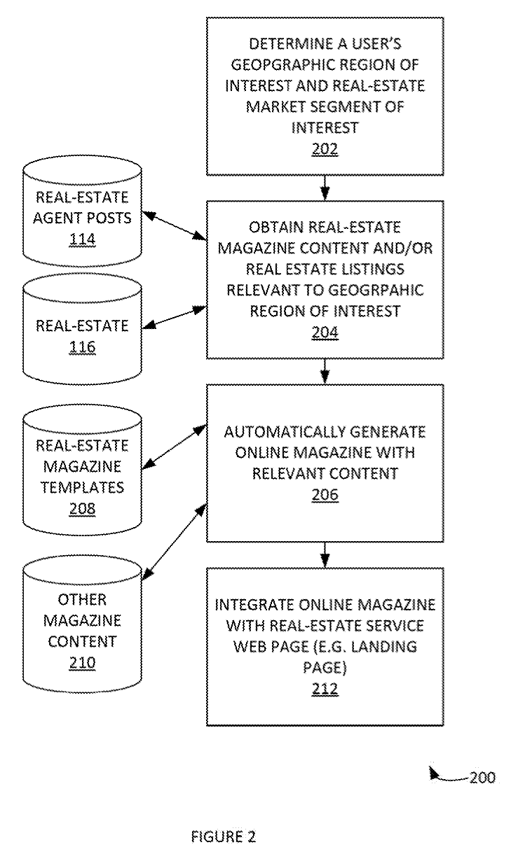

FIG. 2 illustrates an example method 200 of automatically generating an online-real estate magazine, according to some embodiments. It is noted that the online-real estate magazine can be automatically integrated into a real-estate service web site. For example, online real-estate magazine opens “in front” of the web site and keep the context of the web page and search. In step 202, a user's geographic region of interest (e.g. a city, a zip code, a radius around a location, etc.) can be determined. Additionally, a user's real-estate market segment of interest (e.g. home type, home price range, commercial real-estate price range, etc.) can also be determined. This information can be determined from various sources. For example, cookies and/or other web browsing tracking methodologies can be utilized to track a user's web browsing history. The web browsing history can be analyzed to determine geographic regions and price listing ranges of interest to the user. A user's uploaded information (e.g. provided in response to an online form) can be utilized. A search query provided by the user in a search engine of the real-estate website can be obtained and analyzed as well.

In step 204, real-estate magazine content and/or real-estate listing content relevant to the user's geographic region of interest (as well as price-range interest) can be obtained. For example, this content can be pulled from databases 114 and 116 as well as other sources. In step 206, an online real-estate magazine can be automatically generated with relevant content. Various templates 208 and other content 210 (e.g. as provided supra) can be utilized in step 206. In step 212, the online real-estate magazine can be integrated into a real-estate service web page. Real-estate service server(s) 102 can include a multilingual statistical machine-translation service to translate written text from one language into another. In this way, content in one language can be accessible in a plethora of other languages.

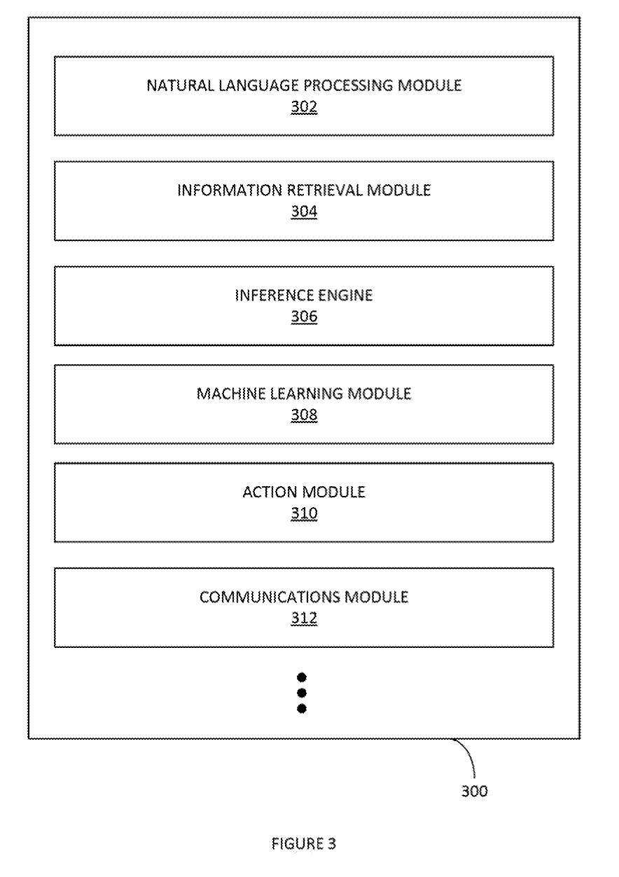

FIG. 3 provide an example computerized automated artificial-intelligence (AI) module 300, according to some embodiments. AI module 300 can be implemented in real-estate server 302. AI module 300 can implement any automated method provided herein. AI module 300 can search the content of databases (e.g. blog databases, government databases, real-estate databases, legal forms databases, etc.) and obtain extract items and/or metadata relevant to a particular real-estate action. AI module 300 can determine a priority of one or more real-estate actions (e.g. based on a user search query, user location, etc.). In various embodiments, AI module 300 can be implemented in a server, in a virtual, in a client-side applications, in a cloud-computing environment and/or any combination thereof.

For example, AI module 300 can include a natural language processing (NLP) module 302. NLP module 302 can implement natural language understanding, part-of-speech tagging, parsing, relationship extraction and/or other NLP algorithms for interpreting a user-generated texts (e.g. a search query, a blog post, etc.).

AI module 300 can include information retrieval module 304. Information retrieval module 304 can search various data sources and obtain information relevant to a real-estate related task. Information retrieval module 304 can include a search-engine functionality. Information retrieval module 304 can also obtain information from various third-party sources (e.g. Google® search, online social network websites, news websites, online real-estate databases, etc.). Information retrieval module 304 can pull all data that a user has permission to access. Example information sources that can be automatically discovered on a periodic basis include: online MLS databases, databases 114 and/or 116, advertisement databases, real-estate digital image and/or video databases, real-estate agent web site databases, etc.; social media sources (e.g. Facebook®, Twitter®, LinkedIn®, etc. and/or messages, notifications, calendars, and/or other social media content); text message (e.g. SMS, WhatsApp®, etc.), phone-call logs, web-browsing histories, mobile device location histories, etc.

AI module 300 can include an inference engine 306. Inference engine 306 can draw conclusions by analyzing database content, in light of a database of expert knowledge it draws upon. Inference engine 306 can reach logical outcomes based on the premises the data establishes. Inference engine 306 can also utilize probability calculations to reach conclusions that the knowledge database doesn't strictly support, but instead implies. In one example, inference engine 306 can cycle through three sequential steps: match rules, select rules, and execute rules. The execution of the rules can result in new facts or goals being added to the knowledge base which will trigger the cycle to repeat. This cycle can continue until no new rules can be matched. Accordingly, a list of real-estate information be generated and refined. It is noted that databases with user information can be automatically sampled by the statistical algorithm. There are several methods which may be used to select a proper sample size and/or use a given sample to make statements (within a range of accuracy determined by the sample size) about a specified population. These methods may include, for example:
1. Classical Statistics as, for example, in “Probability and Statistics for Engineers and Scientists” by R. E. Walpole and R. H. Myers, Prentice-Hall 1993; Chapter 8 and Chapter 9, where estimates of the mean and variance of the population are derived.
2. Bayesian Analysis as, for example, in “Bayesian Data Analysis” by A Gelman, 1. B. Carlin, H. S. Stern and D. B. Rubin, Chapman and Hall 1995; Chapter 7, where several sampling designs are discussed.
3. Artificial Intelligence techniques, or other such techniques as Expert Systems or Neural Networks as, for example, in “Expert Systems: Principles and Programming” by Giarratano and G. Riley, PWS Publishing 1994; Chapter 4, or “Practical Neural Networks Recipes in C++” by T. Masters, Academic Press 1993; Chapters 15,16,19 and 20, where population models are developed from acquired data samples.
4. Latent Dirichlet Allocation, Journal of Machine Learning Research 3 (2003) 993-1022, by David M. Blei, Computer Science Division, University of California, Berkeley, Calif. 94720, USA, Andrew Y. Ng, Computer Science Department, Stanford University, Stanford, Calif. 94305, USA
A Maximum Entropy Model for Part-Of-Speech Tagging, Adwait Ratnaparkhi, University of Pennsylvania, Dept. of Computer and Information Science

It is noted that these statistical and probabilistic methodologies are for exemplary purposes and other statistical methodologies can be utilized and/or combined in various embodiments. These statistical methodologies can be utilized elsewhere, in whole or in part, when appropriate as well.

Machine learning module 308 can learn from previous user behavior. This can be used to increase the accuracies of later interactions with the user. For example, machine learning module 308 can learn from user behavior vis-à-vis a search result of home listings and modify the attributes of later search results based on the user's behavior patterns. For example, a user may provide a query to homes within a certain price range and certain square footage range. The user may not ‘click through’ any homes in the upper end of the price range. Accordingly, machine learning module 308 can learn that the user is more interested in homes at the lower end of the price range. The next time the user performs a search with the same elements, the machine learning module can rank the homes at the lower end of the price range higher (e.g. appear first). Additionally, machine learning module can also prioritize homes in the lower end of the price range when the real-estate service is generating home tours, virtual tours, etc. Moreover, in some embodiments, information about a user learned by machine learning module 308 can be communicated to a relevant real-estate agent and/or other real estate professional. In this way, the online real-estate service can provide both directly observed user behavior but also implied user attributes to assist real-estate professionals in their interactions with the user.

Action module 310 can enable a user to take actions on information provided by AI module 300. Various example actions are provided herein. Action module 310 can enable a user to manually input information and attributes as requested by the other modules of AI module 300. Action module 310 can enable a user manually modify automatically generated list items and their attributes. Action module 310 can enable a user to share real-estate information with other users. Action module 310 can interact with other AI services (e.g. third-party AI services).

Communications module 312 can interact with application programming interfaces (API) of other entities and/or various systems within an enterprise (e.g. human resources database, sales portal, etc.) to obtain information. Communications module 312 can interact mobile-side client applications. Communications module 312 can obtain information from the other modules of and compose natural languages messages (e.g. emails, text messages, push notifications, augmented-reality messages, pop ups, list item text, etc.) to users. Accordingly, communications module 312 can include various human language Natural Language Generation (NLG) functionalities and/or human-language translations functionalities. Communications module 312 can also implement various context awareness methods to determine a user's current context (e.g. geofencing information, location, enterprise context such as position in an enterprise, calendar information, etc.).

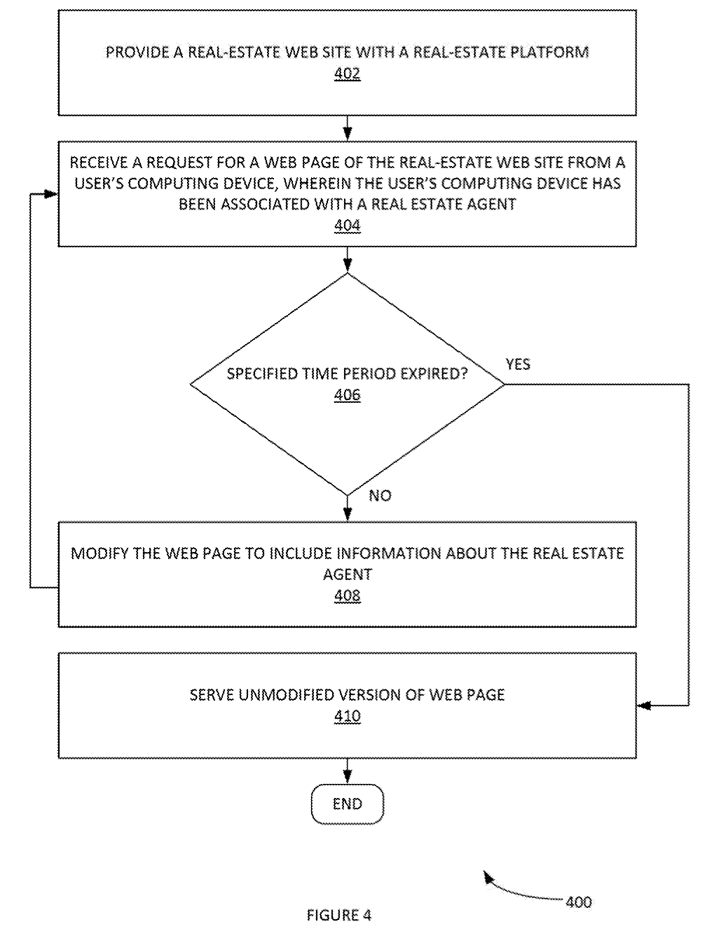

FIG. 4 illustrates another example process of presenting updated real-estate information in a real-estate related web page, according to some embodiments. In step 402, process 400 can provide a real-estate web site with a real-estate platform. In step 404, process 400 can receive a request for a web page of the real-estate web site from a user's computing device, wherein the user's computing device has been associated with a real estate agent. In step 406, process 400 can specified time period expired. In step 408, process 400 can modify the web page to include information about the real estate agent. In step 410, process 400 can serve unmodified version of web page.

Exemplary Environment and Architecture

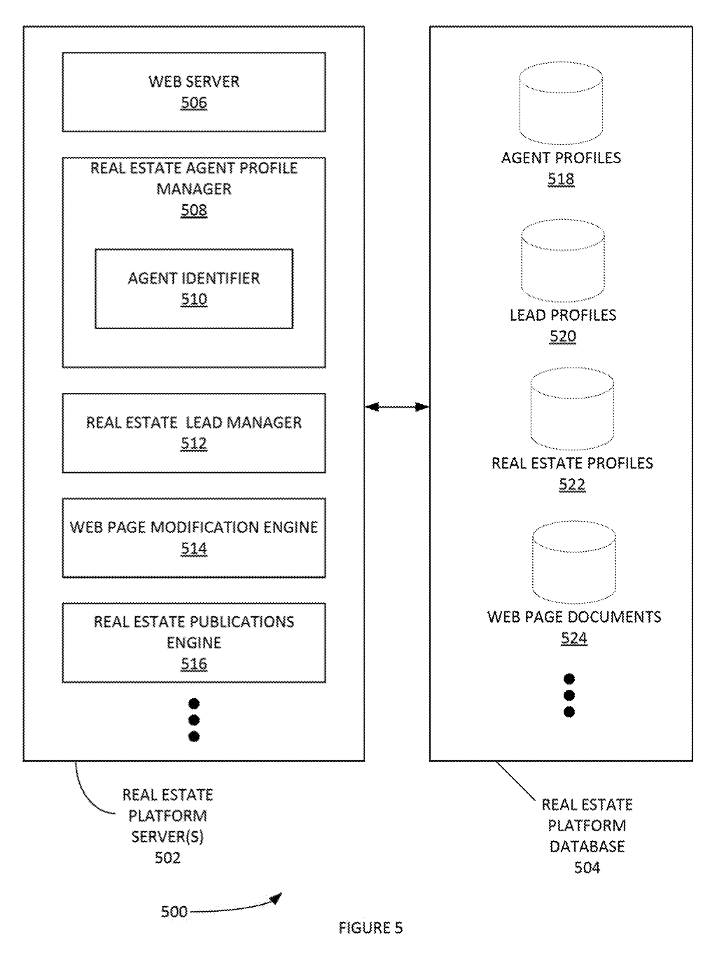

FIG. 5 is a block diagram of an example of a real-estate computing platform 500, according to some embodiments. Real-estate computing platform 500 can implement processes and systems provided herein. Real-estate computing platform 500 can include real-estate computing platform server(s) 502 and real-estate computing platform database(s) 504. Real-estate computing platform server(s) 502 can include various applications and functionalities provided herein. Real-estate computing platform server(s) 502 can include a web server 506. Web server 506 can include hardware and software that deliver web content that can be accessed through the Internet. Real-estate computing platform server(s) 502 can include real estate agent profile manager 508. Real estate agent profile manager 508 can include hardware and software that manage real estate agent profiles. Real estate agents can upload and otherwise generate profiles. These profiles can include biographical information, professional certification information, digital images, digital videos and the like. Real estate agent profile manager 508 can further include an agent identifier 510. Agent identifier 510 can identify referring real estate agents associated with real estate leads (e.g. utilizing the methods provided supra such as mapping URL codes, hyperlink metadata, MAC addresses, HTTP cookies, etc. with specified referring real estate agents). Real estate agent profile information can be stored in agent profiles database 518. Agent profiles database 518 can include real estate lead information such as, inter alia: lead names, lead cookie and other tracking data, associated real estate agent(s), lead profiles, lead interests (e.g. as obtained from the lead's web browsing history in the real estate platform's website), and the like.

Web page modification engine 514 can modify web page documents requested by users to include information about the real estate agent that referred the user to the web site of real estate platform 500. Web page modification engine 514 can implement processes 100, 300 and 400 for example. Web page modification engine 514 can generate the web page 200.

Real-estate computing platform server(s) 502 can include various other modules and tools that implement various other functionalities of the real estate platform 500. For example, real-estate computing platform server(s) 502 can include real estate publications engine 516. Real estate publications engine 516 can automatically generate real-estate related web blogs and/or online magazines based on content provided by real estate agents. This content can be parsed by such factors as, inter alia: location, real estate agent specialization and experience, price ranges of real estate, market analysis, and the like. Real estate profiles 522 can include information about real estate associated with the real estate platform (e.g. digital images, virtual tours, transaction histories, covenants, pricing information, etc.). Web page documents 524 can include the web page documents and other information (e.g. videos, images, and the like) used in the web site. In some embodiments, system 500 can be configured to provide preferred advertising for agents that provide the applications to prospects/leads. Preferred advertising can include priority over other advertisers with respect to locations on a web page, order of display to a web site visitor, size of advertisement with respect to other advertisements, etc.

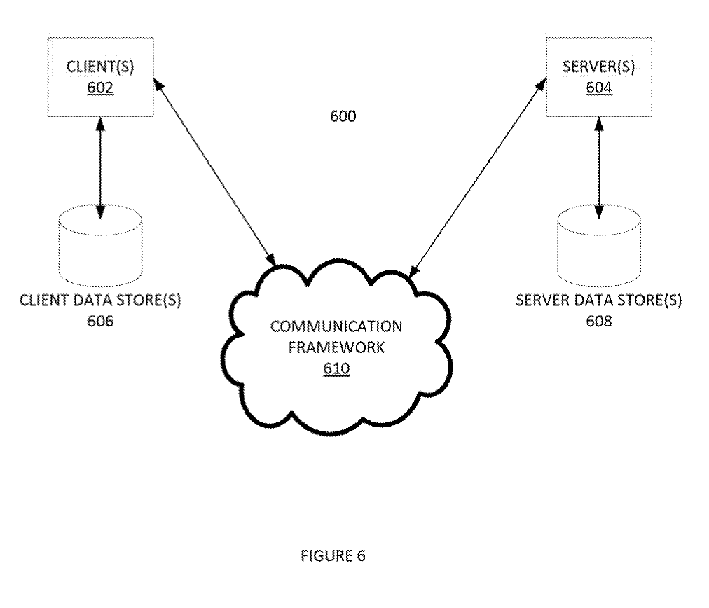

FIG. 6 is a block diagram of a sample computing environment 600 that can be utilized to implement some embodiments. The system 600 further illustrates a system that includes one or more client(s) 602. The client(s) 602 can be hardware and/or software (e.g., threads, processes, computing devices). The system 600 also includes one or more server(s) 604. The server(s) 604 can also be hardware and/or software (e.g., threads, processes, computing devices). One possible communication between a client 602 and a server 604 may be in the form of a data packet adapted to be transmitted between two or more computer processes. The system 600 includes a communication framework 610 that can be employed to facilitate communications between the client(s) 602 and the server(s) 604. The client(s) 602 are connected to one or more client data store(s) 606 that can be employed to store information local to the client(s) 602. Similarly, the server(s) 604 are connected to one or more server data store(s) 608 that can be employed to store information local to the server(s) 604.

FIG. 6 is provided by way of example, in other embodiments, the methods and systems provided herein can be implemented in cloud-computing environments. For example, system 500 can be implemented as a virtual machine(s) in a cloud-computing environment.

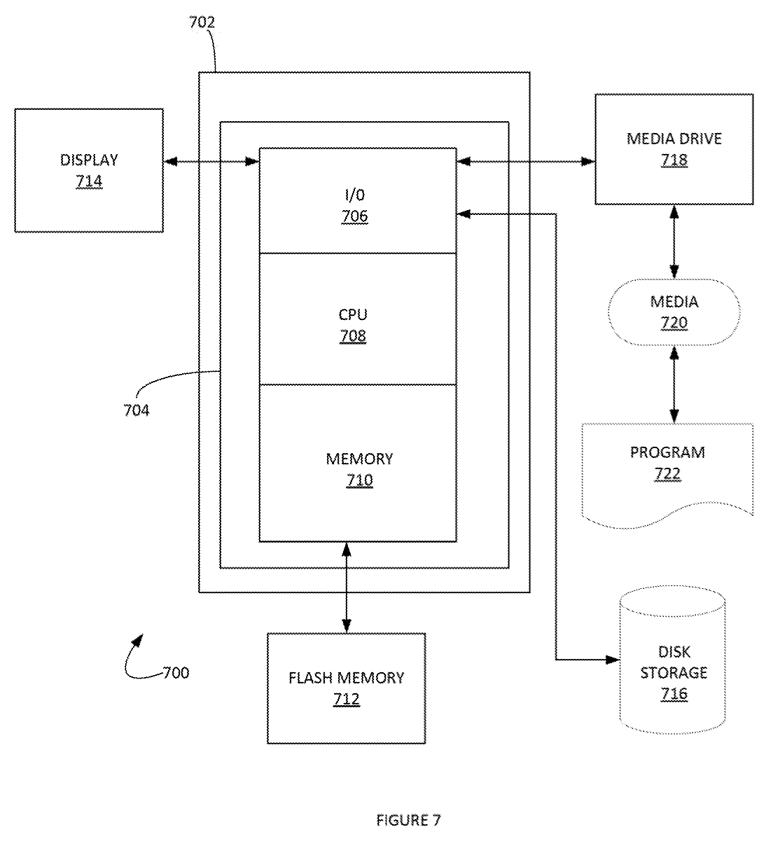

FIG. 7 depicts an exemplary computing system 900 that can be configured to perform any one of the processes provided herein. In this context, computing system 900 may include, for example, a processor, memory, storage, and I/O devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 7 depicts computing system 700 with a number of components that may be used to perform any of the processes described herein. The main system 702 includes a motherboard 704 having an I/O section 706, one or more central processing units (CPU) 708, and a memory section 710, which may have a flash memory card 712 related to it. The I/O section 706 can be connected to a display 714, a keyboard and/or other user input (not shown), a disk storage unit 716, and a media drive unit 718. The media drive unit 718 can read/write a computer-readable medium 720, which can contain programs 722 and/or data. Computing system 700 can include a web browser. Moreover, it is noted that computing system 700 can be configured to include additional systems in order to fulfill various functionalities. In another example, computing system 700 can be configured as a mobile device and include such systems as may be typically included in a mobile device such as GPS systems, gyroscope, accelerometers, cameras, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method of automatically generating an online-real estate magazine comprising:
determining a geographic region of interest of a user and a real-estate market segment of interest of the user;
obtaining a real-estate magazine content;
obtaining a set of real-estate listings, wherein the set of real-estate listings are relevant to the geographic region of interest of the user;
automatically generating the online-real estate magazine with the real-estate magazine content and the set of real-estate listings, wherein online-real estate magazine is accessible via a specified web page, and wherein the online-real estate magazine comprises a set of digital images of the set of real-estate listings;
integrate the online magazine with real-estate service web page.

2. The computerized method of claim 1, wherein the set of real-estate listings are relevant to the geographic region of interest of the user.

3. The computerized method of claim 2, wherein the geographic region of interest is based on a city specified by the user and a radius around the city.

4. The computerized method of claim 3, wherein the set of real-estate listings is relevant to a home type specified by the user and a home-price range specified by the user.

5. The computerized method of claim 4, wherein the geographic region is determined by tracking a user's web browsing history.

6. The computerized method of claim 5, wherein the user's web browsing history is analyzed to automatically determine the geographic region of interest and automatically determine the home-price range based on a user's past search history and a user's past browsing history.

7. The computerized method of claim 6, wherein the set of real-estate listings is based on a high ranking in a walkability index, a high ranking school-rating index, a public transit index, a local restaurant ratings index, a local merchant ratings index and a bicycle-friendly index.

8. The computerized method of claim 2, wherein the set of real-estate listings is relevant to a commercial real-estate price range specified by the user.

9. The computerized method of claim 1, wherein the real-estate magazine content is relevant to the geographic region of interest of the user.

10. The computerized method of claim 4, wherein the real-estate magazine content comprises a set of pre-written blog posts about a real-estate market relevant to the geographic region of interest.

11. A server system for implementing a real-estate computing platform comprising:
a processor configured to execute instructions;
a memory containing instructions when executed on the processor, causes the processor to perform operations that:
determine a geographic region of interest of a user and a real-estate market segment of interest of the user;
obtain a real-estate magazine content;
obtain a set of real-estate listings, wherein the set of real-estate listings are relevant to the geographic region of interest of the user;
automatically generate the online-real estate magazine with the real-estate magazine content and the set of real-estate listings, wherein online-real estate magazine is accessible via a specified web page, and wherein the online-real estate magazine comprises a set of digital images of the set of real-estate listings;
integrate the online-real estate magazine with a real-estate service's web page.

12. The computerized method of claim 11, wherein the set of real-estate listings are relevant to the geographic region of interest of the user.

13. The computerized method of claim 12, wherein the geographic region of interest is based on a city specified by the user and a radius around the city.

14. The computerized method of claim 13, wherein the set of real-estate listings is relevant to a home type specified by the user and a home-price range specified by the user.

15. The computerized method of claim 14, wherein the geographic region is determined by tracking a user's web browsing history.

16. The computerized method of claim 15, wherein the user's web browsing history is analyzed to automatically determine the geographic region of interest and automatically determine the home-price range based on a user's past search history and a user's past browsing history.

17. The computerized method of claim 16, wherein the set of real-estate listings is based on a high ranking in a walkability index, a high ranking school-rating index, a public transit index, a local restaurant ratings index, a local merchant ratings index and a bicycle-friendly index.

18. The computerized method of claim 17, wherein the set of real-estate listings is relevant to a commercial real-estate price range specified by the user.

19. The computerized method of claim 18, wherein the real-estate magazine content is relevant to the geographic region of interest of the user.

20. The computerized method of claim 19, wherein the real-estate magazine content comprises a set of pre-written blog posts about a real-estate market relevant to the geographic region of interest.
